(19) United States
(12) Patent Application Publication
(10) Pub. No.: US 2011/0188882 A1
(43) Pub. Date: Aug. 4, 2011

(54) IMAGE FORMING APPARATUS

(75) Inventor: Tomoyuki Kato, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/019,707

(22) Filed: Feb. 2, 2011

Related U.S. Application Data
(60) Provisional application No. 61/300,859, filed on Feb. 3, 2010.

(51) Int. Cl. G03G 21/20

(52) U.S. Cl. 399/102

(57) ABSTRACT

There is provided an image forming apparatus capable of suppressing the variance of image density.

The image forming apparatus includes a cleaning blade that removes a developer attached on a surface of a photoconductive drum; a case that receives the developer removed from the photoconductive drum by the cleaning blade; a first seal member that seals a gap between an edge of the case and the cleaning blade; and a second seal member that seals a gap between the case and the photoconductive drum at a position located at an upper stream side in a rotational direction of the photoconductive drum in relation to a position where the cleaning blade comes into contact with the photoconductive drum, in which at least one of the first and second seal members has a plurality of holes for ventilation between an inner space and an external space of the case.

### CROSS-REFERENCE TO RELATED APPLICATION

This application is based upon and claims the benefit of priority from U.S. provisional application 61/300,859, filed on Feb. 3, 2010; the entire contents of each of which are incorporated herein by reference.

### FIELD

The present invention relates to a drum cleaner that removes a toner attached on a surface of a photoconductive drum of an image forming apparatus.

### BACKGROUND

Conventionally, an image forming apparatus such as an electrophtographic-type MFP (Multi Function Peripheral) includes a drum cleaner that removes a toner (developer) remaining on a photoconductive drum. Toner images formed on the photoconductive drum are transferred onto a transfer belt or paper. At this time, a part of the toner may remain on the photoconductive drum without being transferred. Since the remaining toner may cause an image disturbance, the drum cleaner removes the remaining toner from the surface of the photoconductive drum.

The drum cleaner includes, for example, a cleaning blade, a collection case, a seal member or the like. The toner, which remains, is removed from the surface of photoconductive drum by the cleaning blade brought into contact with the surface of the photoconductive drum that is rotating, and the toner is collected in the collection case that is opened opposite to the photoconductive drum. In addition, the seal member closes and seals a gap between the collection case and the photoconductive drum for preventing the toner collected in the collection case from being scattered and leaked to the outside of the collection case. Due to this configuration, a sealed space is formed by the cleaning blade, the collection case, the seal member and a part of the surface of the photoconductive drum, and the collected toner may be collected without being leaked to the outside.

However, if a state where the rotation of the photoconductive drum is stopped continues, the variance of density may occur between an image formed by an area facing a space formed by the drum cleaner and the photoconductive drum when the photoconductive drum is stopped and an image formed by the other area in the surface of the photoconductive drum.

### DESCRIPTION OF THE DRAWINGS

FIG. 1 is a configuration view illustrating a figuration of an image forming apparatus according to an embodiment 1;

FIG. 2 is a partial enlarged view illustrating a process unit provided to the image forming apparatus;

FIG. 3 is a partial enlarged view illustrating a drum cleaner;

FIG. 4 is a functional block diagram illustrating a function block related to a pick-up roller position detection process of the image forming apparatus;

FIG. 5 is a partial enlarged view illustrating a drum cleaner according to an embodiment 2;

FIG. 6 is a partial enlarged view illustrating a drum cleaner according to an embodiment 3;

FIG. 7 is a partial enlarged view illustrating a drum cleaner according to a modification of the embodiment 3; and

FIG. 8 is a partial enlarged view illustrating a drum cleaner according to an embodiment 4.

### DETAILED DESCRIPTION

Generally, according to embodiments, an image forming apparatus includes a cleaning blade, a case, a first seal member and a second seal member.

The cleaning blade removes developer attached on a surface of a photoconductive drum. The case receives the developer removed from the photoconductive drum by the cleaning blade. The first seal member seals a gap between an edge of the case and the cleaning blade. The second seal member seals a gap between the case and the photoconductive drum at a position located at an upper stream side in a rotational direction of the photoconductive drum in relation to a position where the cleaning blade comes into contact with the photoconductive drum. At least one of the first and second seal members has a plurality of holes for ventilation between an inner space and an external space of the case.

### Embodiment 1

Hereinafter, an embodiment 1 will be described with reference to accompanying drawings.

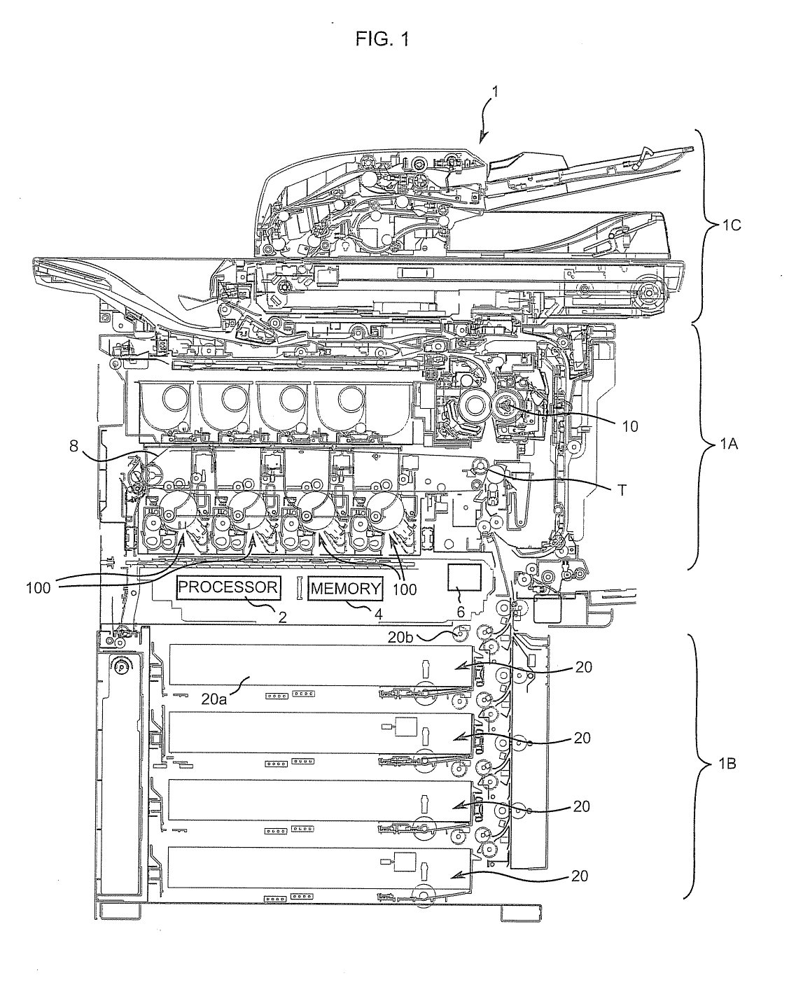

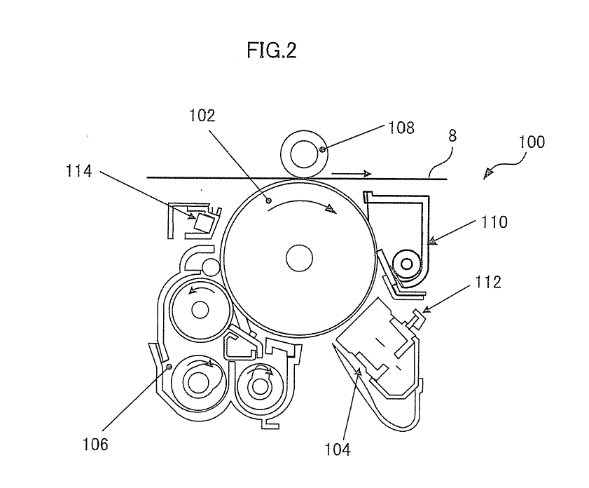

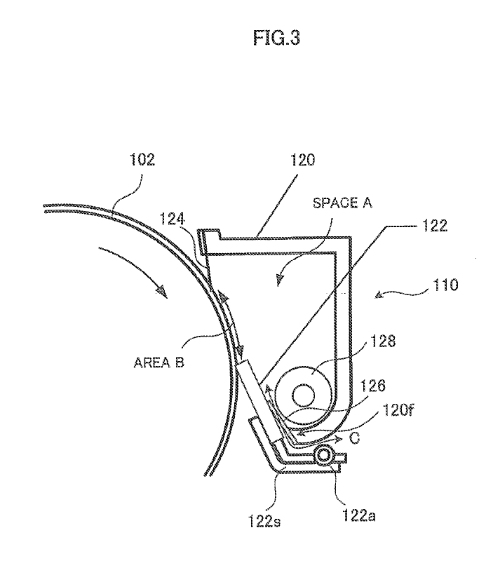

FIG. 1 shows a configuration view illustrating a configuration of an image forming apparatus 1 in this embodiment. FIG. 2 shows a partial enlarged view illustrating a process unit 100 provided to the image forming apparatus 1. FIG. 3 shows a partial enlarged view illustrating a drum cleaner 110 of this embodiment.

The image forming apparatus 1 is an MFP (Multi Function Peripheral) that performs printing, copying or scanning job. The image forming apparatus 1 includes an image forming section 1A that forms an image, a sheet feeding section 1B that feeds a sheet such as paper, an image reading section 1C that reads an image, a processor 2, a memory 4, an auxiliary storage device 6 or the like.

The image forming section 1A forms an image on a sheet fed from the sheet feeding section 1B, based on printing job or copying job. The image forming section 1A includes four process units 100 corresponding to yellow, magenta, cyan and black, respectively, an intermediate transfer belt 8 and a fixing device 10.

The process units 100 form toner images (developer images) of corresponding colors on the intermediate transfer belt 8. As shown in FIG. 2, each of the process units 100 includes a photoconductive drum 102, an electrification charger 104, a developer 106, a primary transfer roller 108, a drum cleaner 110, a neutralization LED 112 and a surface potential sensor 114.

A toner image formed on the photoconductive drum 102 corresponding to each color is transferred onto the intermediate transfer belt 8 from the photoconductive drum 102 and thereby one toner image is formed. The intermediate transfer belt 8 transfers the toner image onto paper at a secondary transfer position T.

The fixing device 10 thermally fixes the toner image transferred onto the paper at a secondary transfer position T to the paper.

An outline of an image forming process performed by the image forming section 1A having the above-described configuration will be described. First, when the image forming apparatus 1 acquires a copy job or a print job, laser beam is emitted onto a surface of the photoconductive drum 102 charged by the electrification charger 104 based on image data of the acquired job, and thereby an electrostatic latent image is formed thereon. The developer 106 supplies toner (developer) onto the photoconductive drum 102 on which the electrostatic latent image is formed. The electrostatic latent image formed on the photoconductive drum 102 is developed by the supply of the toner. The photoconductive drum 102 primarily transfers the toner image onto the intermediate transfer belt 8 at a primary transfer position where the primary transfer roller 108 is disposed. By the rotation of the intermediate transfer belt 8, when the toner image of each color is sequentially and primarily transferred by photoconductive drum 102 of each color and the toner images corresponding to the image data are formed, the toner images are secondarily transferred onto paper conveyed from a paper feeding cassette 20 at a secondary transfer position T. The paper onto which the toner images is transferred is made to move to the fixing device 10, and the fixing device 10 heats the toner images and fixes the toner images on the paper. The paper on which the toner image is fixed is discharged to a paper discharge tray 12 via a transport passage. Hereinbefore, the outline of the image forming process performed by the image forming apparatus 1 is described.

The sheet feeding section 1B feeds a sheet to the image forming section 1A. The sheet feeding section 1B includes a plurality of paper feeding devices 20 including a paper feeding cassette 20a, and a pick-up roller 20b, respectively (a configuration including four paper feeding devices is shown in FIG. 1).

The image reading section 1C is a device that reads out an image from an original document when performing a copy or a scan job and an image reading device provided to a copier or a scanner or the like.

The processor 2 is a processing device that controls various processes in the image forming section 1A, the sheet feeding section 1B, the image reading section 1C or the like. The processor 2 realizes various functions by executing a program stored in the memory 4 and the auxiliary storage device 6 to perform the processes. The processor 2 uses a CPU (Central Processing Unit), an MPU (Micro Processing Unit) that can perform an equivalent operation to the CPU or the like. In addition, a part or the entirety of the functions of the image forming apparatus 1 may be realized by an ASIC (Application Specific Integrated Circuit) as a processor.

The memory 4 is a so-called main storage device storing a program allowing the processor 2 to execute processes such as an image forming process in the image forming section 1A, a sheet feeding process in the sheet feeding section 1B and an image reading process in the image reading section 1C. In addition, the memory 4 provides a temporary job area to the processor 2. As the memory 4, for example, a RAM (Random Access Memory), a ROM (Read Only Memory), a DRAM (Dynamic Random Access Memory), a SRAM (Static Random Access Memory), a VRAM (Video RAM), a flash memory or the like may be used.

The auxiliary storage device 6 stores various pieces of information related to the image forming apparatus 1. As the auxiliary storage device 6, for example, a magnetic storage device such as a hard disk drive, an optic storage device, a semiconductor storage device (flash memory or the like), or a combination thereof may be used.

Next, the details of the drum cleaner 110 of this embodiment will be described with reference to FIG. 3.

The drum cleaner 110 removes toner remaining on a surface of the photoconductive drum 102 after the toner images formed on the photoconductive drum 102 are primarily transferred on the intermediate transfer belt 8. The drum cleaner 110 of this embodiment is disposed above the electrification charger 104 and the electrification LED 110 of each of the process units 100. The drum cleaner 110 includes a collection case 120, a cleaning blade 122, a recovery blade 124 as a second seal member, a seal member 126 as a first seal member, and a waste toner transporting auger 128. Hereinafter, the details of each component making up the drum cleaner 110 will be described.

The collection case 120 receives and temporarily collects the toner that is brushed off from the surface of the photoconductive drum 102 by the cleaning blade 122 of the drum cleaner 110. The seal member 126 is disposed at an edge 120f of the collection case 120. In addition, the recovery blade 124 is disposed at an upper stream-side end, which is opposite to the edge 120f of the collection case 120 in a rotational direction of the photoconductive drum 102.

The cleaning blade 122 is a plate-shaped member that comes into contact with a surface of the photoconductive drum 102 and brushes off the toner from the surface of the photoconductive drum 102 to remove it. The cleaning blade 122 extends in an axial direction of the photoconductive drum 102 and comes into contact with the photoconductive drum 102 over at least a range of the photoconductive drum 102 on which the toner is attached. In addition, in this embodiment, the cleaning blade 122 extends from a lower side of the drum cleaner 110 to an upper side thereof toward the photoconductive drum 102. A distal end of a blade comes into contact with the photoconductive drum 102 against the rotational direction of the photoconductive drum 102. The toner attached to the surface of the photoconductive drum 102 is brushed off from the surface of the photoconductive drum 102 by the cleaning blade 122 and drops down to the collection case 120 to be collected. The cleaning blade 122 may be configured by attaching a blade made of, for example, a material including a urethane rubber as a main component to a supporting plate 122s made of metal.

In addition, the cleaning blade 122 has a movable structure with one end side being supported by a rotational shaft. In this embodiment, as shown in FIG. 3, an end side of a supporting plate 122s is rotatably supported by a rotational shaft 122a. The cleaning blade 122 may be biased against the photoconductive drum 102 by using a spring or a weight (not shown) so as to be brought into the photoconductive drum 102 with a constant pressure.

The recovery blade 124 covers a gap between the collection case 120 and the photoconductive drum 102 for preventing the toner collected in the collection case 120 from scattering to the outside of the case. The recovery blade 124, compared to the cleaning blade 122, is disposed at an upper stream side in the rotational direction of the photoconductive drum 102. The recovery blade 124 is extended from the collection case 120 and is disposed in a manner that the distal end thereof comes into contact with the surface of the photoconductive drum 102.

The seal member 126 covers a gap between the edge 120f of the collection case 120 and the cleaning blade 122. The seal member 126 is disposed to be inclined in a manner that the other end side, compared to one end side fixed to the edge 120f of the collection case 120, is located closely to the cleaning blade 122. Due to the seal member 126, it is possible to prevent the toner removed by the cleaning blade 122 from being leaked to the outside from a gap between the collection case 120 and the cleaning blade 122, which may occur by the moveable structure of the cleaning blade 122.

As the seal member 126 of this embodiment, a porous sheet having a plurality of minute holes is used for the ventilation between a space A inside the drum cleaner 110, which is formed by the collection case 120 and the photoconductive drum 102, and an external space.

This configuration is adopted to realize the ventilation between the space A inside the drum cleaner 110 and the outside and to decrease an atmosphere difference between the inside and the outside. As an atmosphere difference, specifically, a temperature or humidity difference, a density difference of specific gas in a space or the like may be exemplified.

The reason for securing the ventilation property between the space inside the drum cleaner 110 and the external space and for decreasing the variance of atmosphere is to decrease the variance of attachment easiness of the toner onto the surface of the photoconductive drum 102. Specifically, the easiness of attachment of the toner onto the photoconductor drum 102 varies depending on an amount of moisture in the surface of the photoconductive drum 102. Therefore, for example, when the humidity of the space A inside the drum cleaner 110 is higher than that of the outside, if the rotation of the photoconductive drum 102 is stopped and thereby the area B of the photoconductive drum 102 faces the space A in the drum cleaner 120 for a long time, the amount of moisture in the area B of the photoconductive drum 102 becomes larger than that of the other areas that temporarily pass through the drum cleaner 110. As a result, in images formed on the paper, density difference of the images occurs between a portion formed by the toner attached onto the area B and the other portions. For example, if the toner is more easily attached onto the photoconductive drum 102 when the amount of moisture is large, the image corresponding to the area B becomes thicker than that corresponding to the other areas. Especially, if phthalocyanine-based pigment is dispersed and applied to a charge generation layer of the photoconductive drum, it is apt to be affected by humidity and the variance of image density may easily occur.

In addition, similarly, the variance of image density may be caused by the variance of temperature and the variance of density of a certain component in an atmosphere as other cause of the atmosphere difference.

In addition, as the certain component in the atmosphere, ozone may be exemplified. In the image forming apparatus 1, the ozone is generated from the electrification charger 104. Therefore, if the space A inside the drum cleaner 110 is surely sealed, the variance of density of the ozone may occur between, the space A and the external space. Therefore, the variance of density of an image formed on paper may occur between an area heavily (for a long time) affected by the ozone and the other areas among surface areas of the photoconductive drum 102.

Therefore, in this embodiment, the seal member 126 having a plurality of holes is disposed at a gap where the space A inside the collection case 120 and the outside are communicated to seal the gap. Due to the seal member 126, as depicted by both arrows C in FIG. 3, ventilation between the space A and the outside is made to be possible. Therefore, it is possible to decrease the variance of atmosphere between the inner space of the drum cleaner 110 and the external space while preventing the toner from being leaked due to the seal member 126.

An average hole diameter of the seal member 126 for the ventilation is preferably from 5 to 20 μm. If the hole diameter is out of the range, it is difficult to obtain the effect of surely decreasing the variance of atmosphere and thereby it is difficult to suppress the variance of formed image density. In addition, if the average hole diameter is from 5 to 20 μm, particle of the toner does not leak to the outside through the hole.

In addition, the seal member 126 is made of, for example, ultra high molecular weight polyethylene having a weight-average molecular weight of 2 million or more and 8 million or less.

In addition, the thickness of the seal member 126 in a ventilation direction is preferably from 50 to 300 μm.

In addition, on end side of the seal member 126 of this embodiment is fixed to the edge of the collection case 120 and the other end side is brought into contact with the movable cleaning blade 122 to press it and is configured as a free end without being fixed to the cleaning blade 122. Specifically, even though the movable cleaning blade 122 moves, a portion of the seal member 126, which comes into contact with the cleaning blade 122, maintains the contact with the cleaning blade 122 while sliding, such that a gap is not generated. Therefore, it is preferable that the seal member 126 has a low frictional coefficient and an excellent sliding characteristic. The above-described ultra high molecular weight polyethylene may satisfy these conditions.

The waste toner transporting auger 128 is an auger screw that discharges the toner collected in the collection case 120 to the outside. When a shaft of the waste toner transporting auger 128, which is parallel with a shaft of the photoconductive drum 102, rotates, a spiral blade, which is formed around the shaft, pushes out the collected toner. The discharged toner may be reused as a developer or discarded.

Hereinbefore, details of the drum cleaner 110 of this embodiment are described.

According to this embodiment, due to the seal member 126 having a plurality hole, the ventilation between the space formed by the drum cleaner 110 and the photoconductive drum 102 and the external space can be realized. Since the ventilation between the inside of the drum cleaner 110 and the outside can be realized, it is possible to remove the variance of temperature or humidity of the atmosphere of the inside and the outside, a density of specific component of gas, or the like. Since the variance of atmosphere is removed, the variance of a surface state of the photoconductive drum 102 is suppressed, and thereby the variance of image density formed on the paper decreases.

Next, images are actually formed by using an image forming apparatus (example) of this embodiment and a conventional image forming apparatus (conventional example) that uses a drum cleaner provided with a seal member having no ventilation property, and an experiment result illustrating the evaluation of the variance of formed image density will be described.

In examples according to this embodiment, a seal member made of a polyethylene film having a plurality of hole with an average diameter of 17 μm was used as the seal member 126. On the other hand, in the image forming apparatus of conventional example, a polyethylene terephthalate film not having hole and ventilation property was used.

One thousand sheets of paper was passed through each image forming apparatus, and then maintained in a standby state. Then, an image was formed on the paper and it was evaluated whether or not the variance of density was present with respect to the formed image. The evaluation whether or not the variance of image density was present was performed in three levels of A, B and C. A was defined as a level that has no variance of density, B was defined as a level that has partial variance of density but there is no problem in practical use, and C was defined as a level that shows apparent variance of density.

In addition, the standby state was varied into 0 minute (no standby time), 5 minutes, 10 minutes, 15 minutes, 20 minutes, 40 minutes and 60 minutes, and the variance of density was evaluated. In addition, the evaluation of the variance of density was performed in different temperature and humidity conditions, respectively. The temperature and humidity conditions include (1) a temperature of 23° and humidity of 50% (normal temperature and normal humidity), (2) a temperature of 10° and humidity of 20% (low temperature and low humidity), and (3) a temperature of 30° and humidity of 85% (high temperature and high humidity).

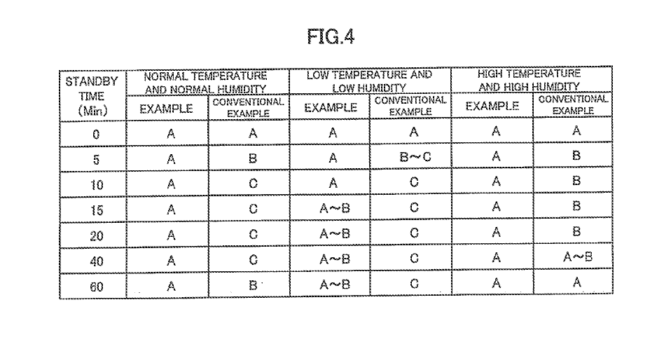

Results of above-described evaluation experiments are shown in FIG. 4.

As shown in a table of FIG. 4, the image forming apparatus of this embodiment was evaluated partially as B when the standby time was 15 minutes or more under low temperature and low humidity condition, but did not show the variance of density in the other conditions. On the other hand, in the conventional image forming apparatus using a drum cleaner provided with a seal member not having a ventilation property, the variance of density was shown in a standby time of 5 minutes or more.

Therefore, according to the image forming apparatus of this embodiment, in the image formed after the standby state, it is possible to form a good image having less variance of density.

### Embodiment 2

Next, an embodiment 2 will be described.

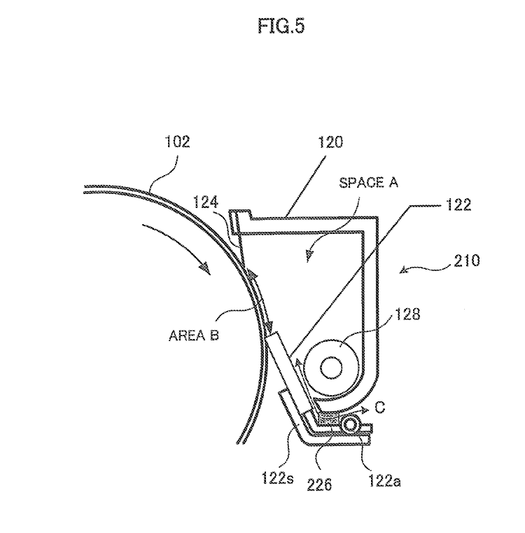

FIG. 5 shows a partial enlarged view illustrating a drum cleaner 210 of the embodiment 2.

An image forming apparatus of the embodiment 2 includes seal member 226 having different configuration from that of the seal member 126 of embodiment 1. Hereinafter, embodiment 2 will be described. Like reference numerals will be given to like parts common to the embodiment 1, and description thereof will be omitted.

The seal member 226 of this embodiment is disposed inside a gap between a collection case 120 and a cleaning blade 122 to seal the gap. As described above, even though the porous seal member 226 is disposed inside the gap between the collection case 120 and the cleaning blade 122, as depicted by both arrows C, the ventilation between a space inside the collection case 120 and an outside space may be realized as similarly to the embodiment 1.

### Embodiment 3

Next, an embodiment 3 will be described.

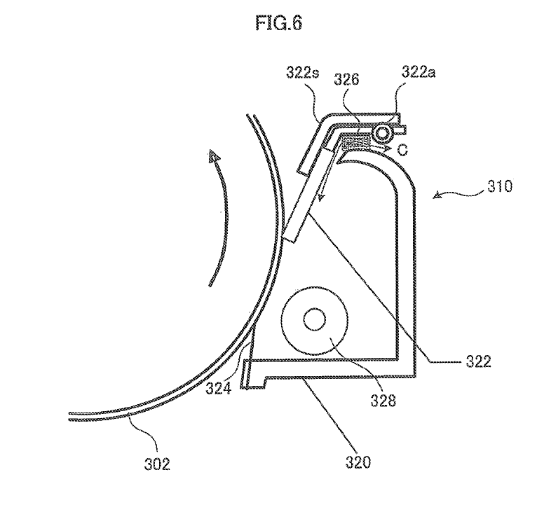

FIG. 6 shows a partial enlarged view illustrating a drum cleaner 310 of the embodiment 3.

The image forming apparatus of the embodiment 3 includes a drum cleaner 310 having a different configuration from that of the drum cleaner 110 of the embodiment 1. Specifically, the image forming apparatus 1 of this embodiment is an image forming apparatus in a type where a photoconductive drum 302 rotates inversely to the embodiment 1.

A cleaning blade 322 of this embodiment is disposed at an upper side of a collection case 320 and comes into contact with the photoconductive drum 302 against the rotation thereof to brush off the toner. In addition, a recovery blade 324 is disposed at a lower side of the collection case 320 to seal a gap between the collection case 320 and the photoconductive drum 302.

A basic configuration of the cleaning blade 322 is common to the embodiment 1 except that an up and down posit ion is inversed. Specifically, in a cleaning blade 322, a blade portion is supported by a supporting plate 322s and one end side of the supporting plate 322s is supported by a rotational shaft 322a. In addition, similarly, the cleaning blade 322 is biased by a force of a spring or the like to come into contact with the photoconductive drum 302 with a constant pressure.

In this embodiment, a seal member 326 is disposed at a gap between the cleaning blade 322 and the collection case 320, which is generated at an upper side of the drum cleaner 310. The seal member 326 has a plurality of holes as similarly to the above-described embodiments. Due to the seal member 326, as depicted by both arrows C in FIG. 6, the ventilation between a space inside the collection case 320 and an external space is realized.

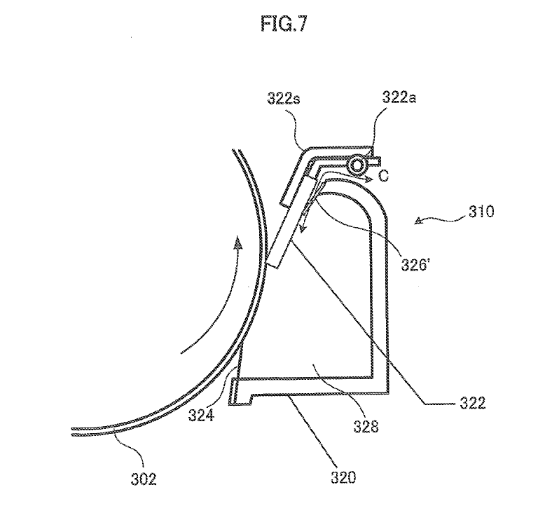

In addition, in FIG. 6, the seal member 326 is disposed inside the gap between the collection case 320 and the cleaning blade 322 as similarly to the embodiment 2, but it is not limited thereto. As shown in FIG. 7, as similarly to the seal member 126 of the embodiment 1, a seal member 326′, of which one end is fixed to the collection case 320 and the other end is disposed to come into contact with the cleaning blade 322 to seal the gap, may be adopted.

In any case, according to this embodiment, a seal member having a plurality of hole is used as a seal member that seals the gap formed at an upper side of the drum cleaner 310, such that the ventilation between a space inside the collection case 320 and the outside is realized. Therefore, it is possible to decrease the variance of atmosphere and the variance of density of an image formed on paper.

### Embodiment 4

Next, an embodiment 4 will be described.

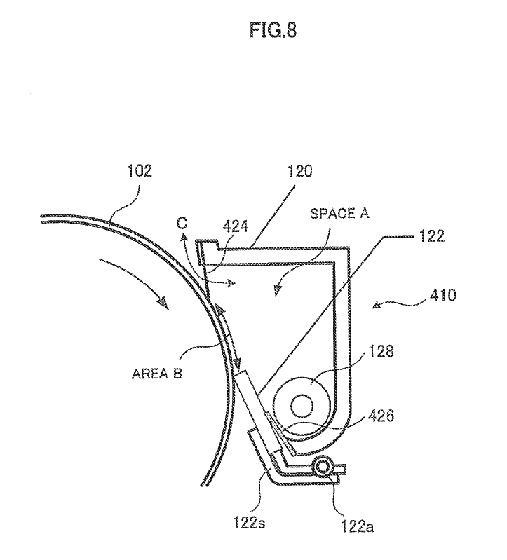

FIG. 8 shows a partial enlarged view illustrating a drum cleaner of the embodiment 4.

The drum cleaner 410 of this embodiment is different from the above-described embodiments in that a recovery blade 424 as a second seal member has a ventilation property and a seal member 426 has no ventilation property and seals gaps. Hereinafter, this embodiment will be described, but like reference numerals will be given to like parts common to the embodiments 1 to 3, and description thereof will be omitted.

The recovery blade 424 of this embodiment is a porous sheet having a plurality of holes, as similarly to the seal member 126 of the embodiment 1. Therefore, ventilation between a space inside the collection case 120 and an external space may be realized through the holes of the recovery blade 424.

In addition, when the holes for the ventilation are formed in the recovery blade 424, the holes may be the same as that of the seal member 126 of the embodiment 1. Specifically, the average hole diameter is preferably 5 to 20 μm. In addition, the material of the recovery blade 424 is not specially limited, but a ultra high molecular weight polyethylene film may be used as similarly to the seal member 126.

As described above, as the recovery blade 424, a recovery sheet having a hole for ventilation is used, such that the ventilation between a space inside the collection case 120 and an external space may be realized and the variance of atmosphere between the inside and the outside is decreased. Therefore, it is possible to suppress the variance of density of an image formed on paper.

In addition, the recovery blade 424 has holes for the ventilation, such that it is not necessary to newly provide a member for the ventilation. Especially, in a configuration where the cleaning blade 122 is not a movable member but a fixed member and a gap is not generated between the cleaning blade 122 and the collection case 120, the seal member 426 is not necessary. In this case, as the recovery blade 424, the recovery sheet having the ventilation property is used like this embodiment, such that it is possible to decrease the variance of image density without providing a new member for the ventilation.

In addition, in this embodiment, the recovery blade 424 is made to have the ventilation property, but both of the recovery blade 424 and the seal member 426 may be configured as a member having the ventilation property. Due to this, it is possible to further decrease the variance of atmosphere between the space inside the collection case 120 and the external space.

As described above, according to the present invention, it is possible to provide an image forming apparatus capable of suppressing the variance of image density.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus, comprising:
a cleaning blade that removes a developer attached on a surface of a photoconductive drum;
a case that receives the developer removed from the photoconductive drum by the cleaning blade;
a first seal member that seals a gap between an edge of the case and the cleaning blade; and
a second seal member that seals a gap between the case and the photoconductive drum at a position located at an upper stream side in a rotational direction of the photoconductive drum in relation to a position where the cleaning blade comes into contact with the photoconductive drum,
wherein at least one of the first and second seal members has a plurality of holes for ventilation between an inner space and an external space of the case.

2. The apparatus according to claim 1,
wherein the first seal member is a sheet-like member of which one end side is fixed to the case and the other end side located at an upper stream side than the one end side in the rotational direction of the photoconductive drum is a free end,
the first seal member is inclined in a manner that the other end side, compared to the one end, is located closely to the cleaning blade side, and
the other end slidably comes into contact with the cleaning blade so as not to interrupt a movement of the cleaning blade.

3. The apparatus according to claim 1,
wherein one end side of the second seal member is fixed to the case and the other end comes into contact with a surface of the photoconductive drum.

4. The apparatus according to claim 1,
wherein at least the seal member having the plurality of holes between the first and second seal members is a member made of a porous resin.

5. The apparatus according to claim 4,
wherein the resin is ultra high molecular weight polyethylene.

6. The apparatus according to claim 1,
wherein an average diameter of the plurality of holes is from 5 to 20 μm.

7. The apparatus according to claim 1,
wherein a thickness of at least the seal member having the plurality of holes between the first and second seal members in a ventilation direction is from 50 to 300 μm.

8. The apparatus according to claim 1,
wherein the photoconductive drum includes a charge generation layer in which phthalocyanine-based pigment is dispersed.

9. An image forming apparatus, comprising:
a cleaning blade that removes a developer attached on a surface of a photoconductive drum;
a case that receives the developer removed from the photoconductive drum by the cleaning blade; and
a seal member that seals a gap between the case and the photoconductive drum at a position located at an upper stream side in a rotational direction of the photoconductive drum in relation to a position where the cleaning blade comes into contact with the photoconductive drum, and has a plurality of holes for ventilation between an inner space and an external space of the case.

10. The apparatus according to claim 9,
wherein one end side of the seal member is fixed to the case and the other end comes into contact with a surface of the photoconductive drum.

11. The apparatus according to claim 9,
wherein the seal member is a member made of a porous resin.

12. The apparatus according to claim 11,
wherein the resin is ultra high molecular weight polyethylene.

13. The apparatus according to claim 9,
wherein an average diameter of the plurality of holes is from 5 to 20 μm.

14. The apparatus according to claim 9,
wherein a thickness of the seal member in a ventilation direction is from 50 to 300 μm.

15. The apparatus according to claim 9,
wherein the photoconductive drum includes a charge generation layer in which phthalocyanine-based pigment is dispersed.
